(19) United States
(12) Patent Application Publication
(10) Pub. No.: US 2019/0262797 A1
(43) Pub. Date: Aug. 29, 2019

(54) SEDIMENT CAPPING LAYER CONSTRUCTED FROM SAND ADHERED SORBENT MATERIAL

(71) Applicant: United States of America as Represented by The Secretary of The Army, Alexandria, VA (US)

(72) Inventors: Steven L Larson, Vicksburg, MS (US); Deborah R Felt, Vicksburg, MS (US); Mandy M Michalsen, Seattle, WA (US)

(21) Appl. No.: 15/908,748

(22) Filed: Feb. 28, 2018

(51) Int. Cl. B01J 20/20; B01J 20/10; B01J 20/26; B01J 20/28; B01J 20/30; C02F 1/28

(52) U.S. Cl. CPC B01J 20/20; B01J 20/10; B01J 20/26; B01J 20/2803; B01J 20/28004; C02F 2103/007; B01J 20/28052; B01J 20/3042; B01J 20/3085; C02F 1/283; B01J 20/28016

(57) ABSTRACT

The invention is a sediment capping structure which utilizes material comprised of an activated carbon physically attached to sand particles. Attachment of the sorbent material to sand particles improves particle density and heterogeneous delivery of the sorptive layer of the sediment cap.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of soil and water purification and more specifically to the field of placing capping layers on contaminated sediment.

### BACKGROUND OF THE INVENTION

The contamination of sediment in rivers, lakes and other bodies of water is an international problem. Many of the world's aquatic environments are contaminated with substances that pose scientifically verified risks to humans and aquatic environments and species. Examples of contaminants include TBT, dioxins, PCBs, PAHs and/or other petroleum products whereas heavy metals can include Pb, Cu, Cr, Cd, Hg and others.

A variety of in place (in situ) and remote (ex situ) methods exist for isolating and remediating contaminated sediments

One method known in the art is in situ sediment capping. Sediment capping is the process of covering contaminated sediment with other materials. Cap designs can be a monolayer of a single material or composite comprised of multiple materials and layers of materials. The barrier formed by the cap may be relatively permeable or impermeable in character, depending on materials and cap design.

Materials used to cap contaminated sediments can be either “inert” or chemically and/or biologically “active” (e.g. containing microbes that digest contaminants).

Inert sediment capping is the process of forming a barrier to cover and isolate contaminated sediment with a non-reactive barrier to prevents upward-migration of contaminants through the cap structure. Inert caps may be constructed of sand, gravel or other materials, including man-made materials referred to as “geo-textiles.” Inert sediment caps known in the art may also include additions of organic carbon to slow the movement of contaminants through the cap.

Active capping utilizes materials which promote remediation of contaminated sediment through biodegradation, contaminant sorption, or phase changes.

Scientists and engineers at the U.S. Army Corps of Engineers (USACE) Center for Contaminated Sediments (CCS), located in the USACE Engineer and Research Development Center's (ERDC's) Environmental Laboratory (EL), conduct research to manage the impact of sediment contamination on the environment.

The use of hydrophobic sorptive materials, such as activated carbon, is known in the art to achieve immobilization of organic contaminants. Sorptive materials are used in sorptive filter techniques, active in-situ sediment capping, and surface water contaminant-removal devices. Sorptive media chemically attaches to dissolved contaminants at the molecular level to remove them from solution.

Sediment caps are frequently constructed of multiple layers of granular materials, like sand, coupled with layers of sorptive material, or mixed with a sorptive material.

Sediment caps using attached activated carbon have shown promise in laboratory and pilot scale studies. However, there are several problems known in the art with respect to the use of activated carbon as a sorptive material for construction of sediment caps.

First, the low density of activated carbons and other sorbent materials interferes with effective delivery of the sorbent materials to the target zone. Sorbent materials are generally delivered by release near the water surface, and their low density results in a slow settling rate. This slow settling rate causes sorbent materials to drift away from the target zone before sinking from the water surface to the contaminated sediment below.

The low density of the activated carbons and other sorbent materials also interferes with effective stratification of different types of filter media and diminishes flow rates. The less dense activated carbon dominates the top portion of the filter. This vertical stratification is undesirable for a system that is predicated on a horizontal flow at varying water levels because the activate carbon is not in contact with the water. The media of the sediment cap must be constantly manipulated and redistributed, making these caps impractical for large-scale use.

Additionally, activated carbon surfaces known in art are not effective for removing organic contaminants dissolved in water until after the carbon surfaces are fully wetted, requiring additional intervention and maintenance of the active sediment cap.

Activated carbon is hydrophobic and wets slowly. Sorptive materials/technologies based on activated carbon are limited by the inefficient wetting rates and low density. These have resulted in limited applications of activated carbon despite this material's high contaminant sorption capacity, stability/reversibility of sorption, low cost, and high availability. Activated carbon is typically wetted and de-aerated prior to use to eliminate air in the pores, and prevent loss of carbon during backwash procedures. There is an unmet need for active sediment capping structures with high densities which can achieve continuous contact between activated carbon and sediment materials without continuous intervention and redistribution of the sediment layers and re-wetting.

### SUMMARY OF THE INVENTION

The invention is a sediment capping structure which utilizes material comprised of an activated carbon physically attached to sand particles. Attachment of the sorbent material to sand particles improves particle density and accurate, heterogeneous delivery of the sorptive layer of the sediment cap.

Various embodiments of the structure and method disclosed herein utilize a composite particle size and density that is equal to or greater than the granular material used as the primary component of a permeable cap. In various embodiments, sand is the granular material that is the primary component of a permeable cap.

The invention disclosed herein is an activated carbon-based media in which a polymer coating eliminates the need for wetting of the sorbent material before decontamination, allowing passive initiation of decontamination filtering processes.

### BRIEF DESCRIPTION OF SEVERAL VIEWS OF THE DRAWING(S)

FIG. 1 illustrates an exemplary sediment capping structure constructed from activated carbon particles bound to sand using a binding agent.

FIG. 2 illustrates an exemplary method for creating a sand adhered sorbent media for use in sediment capping structures.

FIG. 3 illustrates exemplary binding rates of Powdered Activated Carbon to sand particles.

FIG. 4 illustrates exemplary results of the comparative effectiveness of activated carbon bound to sand particles and unbound activated carbon particles when removing contaminants.

### TERMS OF ART

As used herein, the term “activated carbon” means a form of carbon processed to have small, low-volume pores that increase the surface area available for adsorption or chemical reactions. Alternate names for activated carbon include active carbon, activated charcoal, or active charcoal.

As used herein, the term “adhere” or “adherence” refers to encapsulating or binding to another material (e.g. sand), or to a material having the capacity to bind due to electrostatic charges or intermolecular attraction, curing /and or encapsulation or a combination of the foregoing.

As used herein, the term “containment layer” means a layer of material that prevents contaminants from entering water.

As used herein, the term “curing” means processing the polymer to harden it and secure the bond between the polymer and a material. The curing process may include exposing a polymer to heat, UV light, electron beams, chemical additives, or other conditions.

As used herein, the term “dry application method” means a method of applying sediment cap material which does not include wetting the material.

As used herein, the term “layer height” means the height of a layer.

As used herein, the term “material mass” means the measurable mass of used material.

As used herein, the term “polymer” means a natural or synthetic material comprised of repeated subunit molecules, or macromolecules, having different molecular weights; any material having sufficient molecular weight to adhere to sand.

As used herein, the term “sand” means any particle capable of being bound to a sorbent material by using a polymer; sand may be natural or man-made; sand includes but is not limited to rocks, stones, and other high-density materials with appropriate grain size and surface area.

As used herein, the term “settling rate” means the speed at which a material sinks through a medium; the medium may include water.

As used herein, the term “slurry mover” means a process known in the art for moving, applying or redistributing particulate and/or other solids materials by mixing the particulate and/or solid matter with water.

As used herein, the term “sorbent material” means a particle that can bind to a contaminant, which acts by adsorption; sorbent materials may include but are not limited to activated carbon, mesoporous silica, mesoporous and microporous carbon or any organic natural or synthetic material having sorbent.

As used herein, the term “unbound PAC” means powdered activated carbon that is not bound to another material.

As used herein a “water column” is an area of water extending from the surface of a sea, river or lake to the bottom sediments.

### DETAILED DESCRIPTION OF THE INVENTION

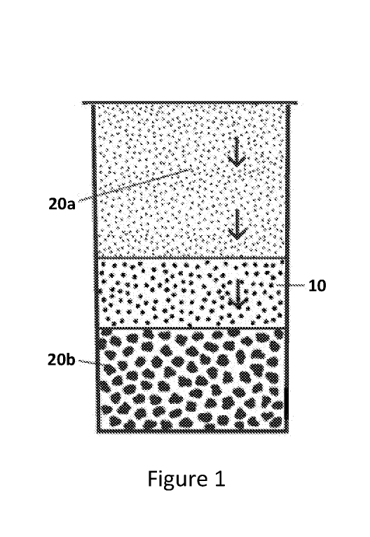

FIG. 1 illustrates an exemplary sediment capping structure constructed from activated carbon particles bound to sand using a binding agent.

In the exemplary embodiment shown, sorptive layer 10 is placed between two containment layers 20a and 20b.

In various embodiments, sorptive layer 10 includes sorbent material.

In various embodiments, the sorbent material that may be utilized is powdered activated carbon (PAC) bound to a thermoplastic polymeric material and sand grains, or sand-adhered PAC. Adhering PAC to sand increases the settling rate of PAC to approximately equal the settling rate of the sand and allows more accurate delivery of the sorbent material in sorptive layer 10. In various embodiments, sand may include rocks, gravel, stones or other high density material with appropriate grain size and surface area.

In various embodiments, the sorbent material in sorptive layer 10 is any material that can absorb contaminants, such as activated carbon, organoclays, microbes, mesoporous silica, mesoporous and microporous carbon, crushed peanut hulls, feathers, natural sorbent materials, and synthetic sorbent materials.

In various embodiments, the activated carbon may be derived from charcoal, that has been processed to make it extremely porous and may have a very large surface area available for adsorption or chemical reactions.

Various embodiments may utilize powdered activated carbon (PAC), which may exist in a particulate form with granules less than 1.0 mm in size, with an average diameter between 0.15 and 0.025 mm. These particles present a large surface to volume ratio with a small diffusion distance between the contaminant and available adsorption sites following wetting. Particle choice will vary based on desired settling rates and factors known in the art.

Various embodiments of the invention may capture compounds that have low water solubility and high hydrophobicity, like polycyclic aromatic hydrocarbons (PAHs), polychlorinated biphenyls (PCBs), chlorinated solvents, explosives, and other organic compounds.

In various embodiments, the binding agent that connects the sorbent material and the sand may be any polymer.

In one embodiment, making sand-adhered PAC requires mixing 570 grams of water, 3,720 grams of #30 mesh sand, 200 grams of PAC, and 30 grams of polyvinyl alcohol (PVA), then curing the mixture.

In one embodiment, PAC mass loading on sand in the 2 to 5% range is feasible using simple production methods.

In one embodiment, the mixture is stirred at 5 minute intervals over the first hour of the curing period and the result is individual sand grains with a PAC/polymer coating.

In another embodiment, the mixture stands undisturbed during the curing process and may form a “cake” or aggregate of the material. This material consists of sand grains that are attached to other sand grains as well as the PAC by the cured polymer. Once cured, this cake can be broken into a range of particle sizes or even down to individual sand grains coated with PAC.

In the embodiment shown, containment layers 20a and 20b are critical for protecting the sorptive layer, for capturing contaminants that leak through the sorptive layer before they reach the adjacent water, and for maintenance of biological activity at the cap/water interface. In the embodiment shown, containment layers 20a and 20b do not include sorbent material.

In one embodiment, materials that will form sorptive layer 10 and containment layers 20a and 20b are combined and mixed with water to create a thick fluid known as a slurry. The slurry containing sand and sand-adhered sorbent material can be applied in a single step to create sediment cap structure 100. As the slurry settles, it separates into layers because the material in sorptive layer 10 has a settling rate that is different from that of the material in containment layers 20a and 20b.

Compared to applications that require multiple passes, single step application reduces time, energy, and potential temporal variations in cap delivery that can occur when performing multiple passes. Multiple passes have been shown to increase the possibility of the capping material displacing or mixing with the contaminated material.

In one embodiment, the PAC/polymer/sand mixture was dry when applied and also produced clean capping layers overcoming the surface tension, surface area and void volume issues observed for the fine-grain PAC/polymer coated particles. Dry application of sorptive layer 10 produces cost savings in time and labor. Unlike activated carbon, which resists water, the sand-adhered PAC material undergoes rapid wetting upon contacting water, eliminating the need to pre-wet the material before application.

These materials can produce reactive layered caps for contaminant sorption purposes with both wet (slurry) and dry application and media for sorptive filters that can operate while cycling through wet-dry conditions.

In one exemplary embodiment, treatment with the PAC/polymer/sand technology reduced contaminant concentrations in amounts similar to those obtained using activated carbon alone, which meet surface water quality standards.

Preliminary studies for sorption of poly aromatic hydrocarbons (PAHs) using these materials from aqueous solution containing phenanthrene provide initial indications that the binding agents do not interfere with the extent of removal of phenanthrene from water solutions. Preliminary studies for sorption of a wide range of explosives compounds using these materials from aqueous solution containing explosives provide initial indications that the binding agents greatly accelerate the wetting process for activated carbon compared to activated carbon only.

In various embodiments, passively initiated sediment caps with sand-adhered sorbent media may be used to filter surface waters, ground waters, production waters, spill waters, and sediments in multiple environments.

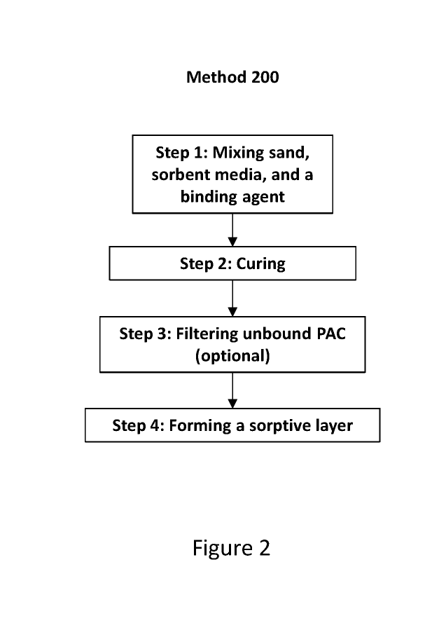

FIG. 2 illustrates exemplary method 200 for creating a sand adhered sorbent media for use in sediment capping structures.

Step 1 is the step of mixing sand, sorbent media, and a binding agent.

In various embodiments, this step includes mixing water, sand, sorbent material, and a binding agent, and curing the mix to create a sand-adhered sorbent media. In one exemplary embodiment, the sand is #30 mesh sand, the sorbent material is powdered activated carbon (PAC), and the polymer binding agent (adhesive) is polyvinyl alcohol (PVA).

Step 2 is curing the PAC/sand mixture.

In one exemplary embodiment, the mixture is stirred at 5 minute intervals over the first hour of the curing period. The result is individual sand grains with a PAC/polymer coating. In another exemplary embodiment, the mixture is allowed to stand during the curing process, and the result is the formation of a “cake” of material. This material consists of sand grains that are attached to other sand grains as well as the PAC by the cured polymer. Once cured, this cake can be broken into a range of particle sizes or even down to individual sand grains coated with PAC.

Step 3 is the optional step of filtering unbound PAC.

After curing, the mixture may be filtered using a #60 mesh (0.25 mm) soil sieve in order to remove PAC that was not adhered to sand particles. The mass of PAC recovered was 41 grams, indicating that 159 grams, 79% of the PAC used in the initial mix, was present on the sand. This represents a 4.27% mass loading of PAC on the sand material. In a large-scale production process, this unattached PAC could be re-introduced into a later batch mix so the 21% that does not attach would not be a wasted material.

Step 4 is the step of forming a sorptive layer. In this step, sand-adhered sorbent material is spread over the contaminated area to form a sorptive layer. In one exemplary embodiment, the material is dry when it is spread over the contaminated area. In another exemplary embodiment, the material is wet when it is spread over the contaminated area.

In various embodiments, containment layers may be formed next to the sorptive layer in a multiple pass application.

In still other embodiments, the materials for the sorptive layer and the containment layer may be mixed and applied simultaneously. The more rapid settling rate of the larger, PAC/polymer coated sand particles relative to the finer, clean sand causes the materials to settle in distinct layers to create a layered cap.

In various embodiments, the height of each layer can be controlled by adjusting the mass of material per water surface area in order to achieve site specific heights for contaminant sequestration and protection of the reactive cap. Similar results were achieved without pre-wetting the capping mixture.

In various embodiments, layer height may be chosen based on the velocity of the water current and the type of contamination. The effectiveness of the containment layers in shielding the sorptive layer depends on the height of each containment layer. In various embodiments, produced layers may be thick enough to prevent burrowing benthic organisms from becoming contaminated.

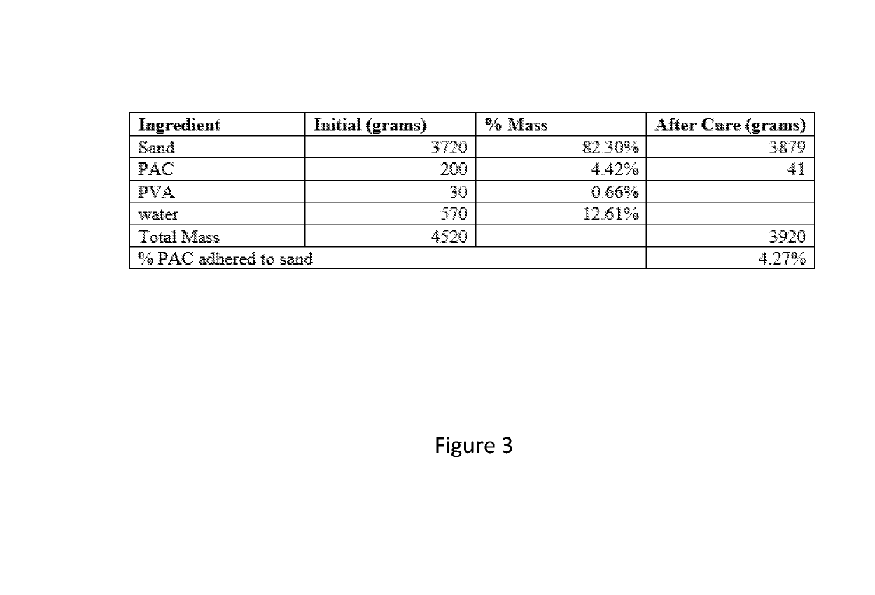

FIG. 3 illustrates exemplary binding rates of Powdered Activated Carbon to sand particles.

In one embodiment, 570 grams of water, 3,720 grams of #30 mesh sand, 200 grams of PAC, and 30 grams of polyvinyl alcohol (PVA), are combined and cured to create sand adhered PAC.

In various embodiments, the cured mixture may be separated using a #60 mesh (0.25 mm) soil sieve in order to remove PAC that was not adhered to sand particles. In the exemplary embodiment shown, the mass of PAC recovered is 41 grams, indicating that 159 grams, 79% of the PAC used in the initial mix, is present on the sand. This represents a 4.27% mass loading of PAC on the sand material. In various embodiments with a large-scale production process, this unattached PAC could be re-introduced into a later batch mix so the 21% that does not attach would not be a wasted material.

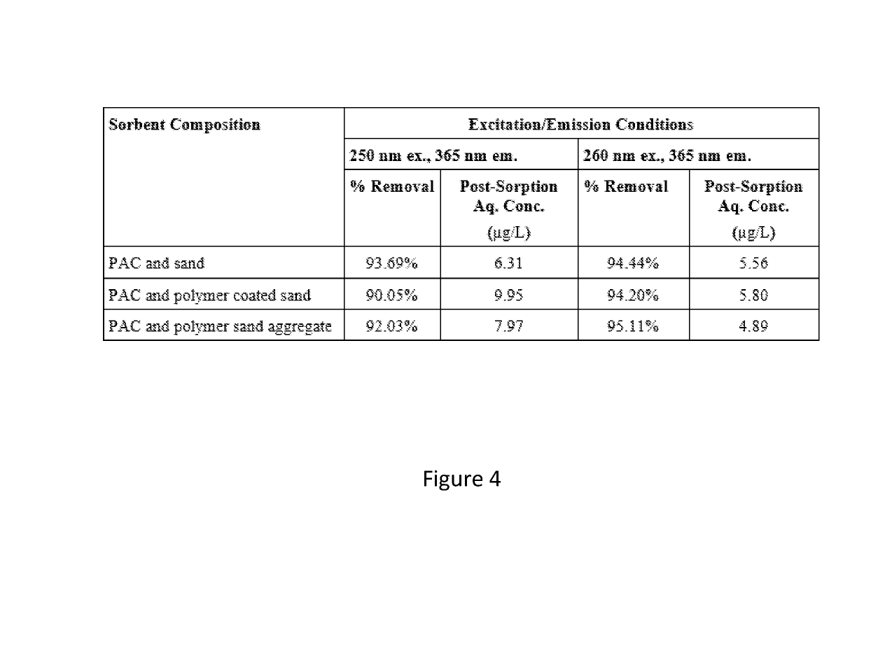

FIG. 4 illustrates exemplary results of the comparative effectiveness of activated carbon bound to sand particles and unbound activated carbon particles when removing contaminants.

In the exemplary results shown, sorptive layers filtered phenanthrene contaminated water with a concentration of 100 parts per billion (ppb); then, a fluorometer measured the amount of phenantrene remaining after filtration. Three different types of sorptive layers (PAC and sand, individual grains of sand-adhered PAC, or aggregated clumps of sand-adhered PAC) each individually filtered the contaminated water. Both types of sand-adhered PAC achieved approximately 92-95% removal of the contaminant, similar to the 93-95% removal achieved by the unbound PAC.

In similar tests, one of five explosives contaminants (nitroguanidine —NQ, 3-nitro-1,2,4-triazol-5-one (NTO), hexahydrotrinitrotriazine (ROX), 2,4,6-trinitrotoluene (TNT), and 2,4-dinitroanisole (DNAN) at concentrations ranging from 10 to 120 ppm, was filtered five times. Filtrate from each addition was collected and analyzed for explosives content using high performance liquid chromatography (HPLC) method.

The activated carbon attached to sand removed all the tested explosives compounds to non-detection, compared to partial reduction by the activated carbon amendment. The sand/powdered activated carbon performed as expected with removal efficiencies ranging from 63 to 74% for the range of contaminants during the 5th filtering step. The sand/activated carbon/polymer material greatly exceeded the performance of the sand/PAC media with removal efficiencies ranging from 63 to 74% for the range of contaminants during the 1st filtering step, and removal efficiencies of 99% and greater for the range of contaminants during the 5th filtering step. The capping materials adsorbed 90% to 95% of polycyclic aromatic hydrocarbon (PAH) contaminants from water.

In one exemplary embodiment, treatment with the PAC/polymer/sand technology reduced contaminant concentrations in amounts similar to those obtained using activated carbon alone, which meet surface water quality standards.

Preliminary studies for sorption of poly aromatic hydrocarbons (PAHs) using these materials from aqueous solution containing phenanthrene provide initial indications that the binding agents do not interfere with the extent of removal of phenanthrene from water solutions. Preliminary studies for sorption of a wide range of explosives compounds using these materials from aqueous solution containing explosives provide initial indications that the binding agents greatly accelerate the wetting process for activated carbon compared to activated carbon only.

What is claimed is:

1. A sediment cap apparatus comprised of:
at least one containment layer, wherein said at least one containment layer is comprised of a quantity of sand, a quantity of polymer and a quantity of sorbent material compound;
wherein said at least one containment layer has a settling rate; and
wherein said at least one containment layer is of sufficient thickness to form a barrier between a contaminated sediment surface and a water column.

2. The apparatus of claim 1 wherein said polymer is adhered to said sand and said sorbent material.

3. The apparatus of claim 1 wherein said sorbent material is activated carbon.

4. The apparatus of claim 1 wherein said sorbent material is selected from a group consisting of activated carbon, mesoporous silica, mesoporous and microporous carbon, natural sorbent materials, and synthetic sorbent materials.

5. The apparatus of claim 1 wherein said sand is selected from a group consisting of sand, rocks, stones, and gravel.

6. The apparatus of claim 1 wherein said sand is a high density material with appropriate grain size and surface area.

7. The apparatus of claim 1 wherein said polymer is selected from a group consisting of polymers having a minimum molecular weight of 100,000 daltons.

8. The apparatus of claim 1 wherein said settling rate is a target settling rate.

9. The apparatus of claim 8 wherein said target settling rate is approximately the settling rate of sand of approximately equivalent particle size, wherein said sand of approximately similar particle size has not been coated.

10. The apparatus of claim 1 wherein said at least one containment layer includes a proportion of polymer that is inversely correlated with sand particle size and sorbent particle size.

11. The apparatus of claim 1 wherein said at least one containment layer includes a proportion of sorbent material which increases as sorbent particle size increases.

12. The apparatus of claim 1 wherein said settling rate is inversely correlated with proportion of sorbent material.

13. The apparatus of claim 1, wherein particle diameter of said sand is approximately 0.2 mm to 10 cm.

14. The apparatus of claim 1, wherein said sorbent material is powdered activated carbon (PAC).

15. The apparatus of claim 14, wherein said powdered activated carbon (PAC) particles each have a diameter of less than 1.0 mm with an average diameter between 0.15 and 0.025 mm.

16. A method of creating a sorbent media sand sediment cap comprised of:
mixing a compound;
curing; and
forming a sorptive layer.

17. The method of claim 16, which further includes the step of filtering a cured compound.

18. The method of claim 16, which further includes the step of forming at least one containment layer.

19. The method of claim 16, wherein the step of forming a sorptive layer requires a slurry application method.

20. The method of claim 16, wherein the step of forming a sorptive layer requires a dry application method.
